(19) United States
(12) Patent Application Publication
(10) Pub. No.: US 2017/0341027 A1
(43) Pub. Date: Nov. 30, 2017

(54) Osmotic Power Plant

(71) Applicant: Siemens Aktiengesellschaft, Muenchen (DE)

(72) Inventor: Markus Ziegmann, Baiersdorf (DE)

(73) Assignee: Siemens Aktiengesellschaft, Muenchen (DE)

(21) Appl. No.: 15/533,278

(22) PCT Filed: Dec. 18, 2015
(86) PCT No.: PCT/EP2015/080393

§ 371 Date: Jun. 5, 2017

(30) Foreign Application Priority Data
Jan. 12, 2015 (DE) 10 2015 200 250.0

(51) Int. Cl. B01D 61/00; B01D 1/14; B01D 5/00; F03G 7/00

(52) U.S. Cl. CPC B01D 61/005; F03G 7/005; B01D 1/14; B01D 5/0027; B01D 5/006

(57) ABSTRACT

The present disclosure relates to osmotic power plants and method for their operation. For example, a method for operating an osmotic power plant may include: supplying a starting solution containing a first substance to the thermal separating facility; evaporating the starting solution in an evaporator; discharging the substance out of the evaporator with a gaseous medium flowing through the evaporator; converting the discharged substance to a liquid phase in a condenser and thereby generating the first solution; wherein the substance is more easily converted to a gas phase than the solvent of the starting solution. The first solution has a first concentration the substance dissolved in a solvent. A second solution has a second, lesser concentration of the substance. The first solution is provided by a thermal separating facility.

### CROSS-REFERENCE TO RELATED APPLICATIONS

This application is a U.S. National Stage Application of International Application No. PCT/EP2015/080393 filed Dec. 18, 2015, which designates the United States of America, and claims priority to DE Application No. 10 2015 200 250.0 filed Jan. 12, 2015, the contents of which are hereby incorporated by reference in their entirety.

### TECHNICAL FIELD

The present disclosure relates to osmotic power plants and method for their operation.

### BACKGROUND

Osmotic power plants or osmotic storage power plants are currently the subject of intensive research, and some few pilot installations are ready for operation. In the case of an energy production process occurring in an osmotic power plant, reverse osmosis or electro dialysis is operated backwards. Reverse osmosis is known, for example, from the treatment of drinking water. This reverse process of reverse osmosis is termed “pressure retarded osmosis” (PRO). By contrast, the electro dialysis that occurs in reverse is termed “reversed electro dialysis” (RED).

### SUMMARY

Some embodiments employ a first solution, having a first concentration of at least one substance that can be dissolved in a solvent of the solution, and a second solution. The second solution has a second, lesser concentration of the at least one substance. At least the first solution is provided by means of at least one thermal separating facility.

In some embodiments, a method for operating an osmotic power plant (1) may include: in the at least one thermal separating facility (12), a starting solution (18) that contains the at least one substance (20) is introduced into an evaporator (17), through which there flows a gaseous medium, wherein the at least one substance (20) is discharged out of the evaporator (17) by means of the gaseous medium, wherein the at least one substance (20) that is discharged in the gaseous medium is converted to a liquid phase in a condenser (22) of the at least one thermal separating facility (12), in order to provide the first solution (3), and wherein used as the at least one substance (20) in the starting solution (18) is one that can more easily be converted to the gas phase than the solvent of the starting solution (18).

In some embodiments, water is used as the solvent of the starting solution (18), and ammonium carbonate and/or at least one acid or base and/or at least one polar organic compound is/are used as the at least one substance (20).

In some embodiments, if the at least one acid or base is used, the pH value in the at least one thermal separating facility (12) is set in such a manner that a greater proportion of the at least one acid or base is present in its non-dissociated form in the evaporator (17) than without the setting of the pH value.

In some embodiments, the pH value in the evaporator (17) is set by addition of a further acid or base that has a greater acid strength or base strength than the at least one substance (20).

In some embodiments, in the condenser (22), the starting solution (18) is used as a coolant for cooling the gaseous medium containing the at least one substance (20).

In some embodiments, a temperature of the starting solution (18) coming from the condenser (22) is increased, and the starting solution (18) having the increased temperature is trickled in a counterflow in relation to the gaseous medium in the evaporator (17).

In some embodiments, the solvent, after passing through the evaporator (17), is cooled to a temperature that is lower than a temperature of the gaseous medium that, coming from the condenser (22), is introduced into the evaporator (17), in a bottom region (28).

In some embodiments, the starting solution (18) discharged out of the evaporator (17), depleted with respect to the at least one substance (20), is used to provide the second solution (4).

In some embodiments, the at least one thermal separating facility (12) is operated at a pressure that corresponds to a pressure in the environment of the at least one thermal separating facility (12).

In some embodiments, at least the first solution (3) is provided by means of at least two thermal separating facilities (12), wherein the solution originating from the condenser of a first separating facility (12), enriched with respect to the at least one substance (20), is supplied as a starting solution (18) to the evaporator (17) of a second separating facility (12).

In some embodiments, the first solution (3) and the second solution (4) are supplied to a facility (2) in which energy is obtained by means of a reversed electro dialysis and/or by means of a pressure retarded osmosis.

Some embodiments include a osmotic power plant having a facility (2) that has a first inlet (6) for a first solution (3) having a first concentration of at least one substance (20) that is soluble in a solvent of the first solution (3), and a second inlet (7) for a second solution (4) that has a second, lesser concentration of the at least one substance (20), wherein the first inlet (6) is connected to a first reservoir (8) for the first solution (3), and the second inlet (7) is connected to a second reservoir (9) for the second solution (4), wherein at least the first reservoir (8) is connected to at least one thermal separating facility (12). A starting solution (18), containing the at least one substance (20), and a gaseous medium are present in an evaporator (17) of the at least one thermal separating facility (12), wherein the at least one substance (20) can be discharged out of the evaporator (17) by means of the gaseous medium, wherein the evaporator (17) is connected to a condenser (22) of the at least one thermal separating facility (12), which is designed to convert the at least one substance (20), that is discharged in the gaseous medium, to a liquid phase, and wherein used as the at least one substance (20) in the starting solution (18) is one that can more easily be converted to the gas phase than the solvent of the starting solution (18).

### BRIEF DESCRIPTION OF THE DRAWINGS

The features and feature combinations stated above, and the features and feature combinations stated in the following in the description of the figures and/or shown in the figures alone, are applicable, not only in the respectively specified combination, but also in other combinations or singly, without departure from the scope of the teachings herein. Embodiments that are not explicitly shown or explained in the figures, but that ensue from and can be produced from the explained embodiments by separate feature combinations, are therefore also to be considered to be comprised and disclosed herein.

Further advantages, features and details are disclosed by the claims, the following description of example embodiments, and on the basis of the drawings. There are shown:

FIG. 1 in highly schematic form, an osmotic power plant in which a thermal separating facility is used to provide two solutions having differing concentrations of a dissolved substance according to teachings of the present disclosure; and

FIG. 2 the thermal separating facility, in schematic form.

### DETAILED DESCRIPTION

In these processes, use is made of the energy, in the form of the Gibbs energy or free enthalpy, that is released in the mixing process between a low-concentration solution and a high-concentration solution. On the other hand, in the case of reverse osmosis and in the case of electro dialysis, a solution containing impurities, such as, for example, water having the impurities in the form of salts, is separated by the use of energy, into a low-concentration solution in the form of clean water, and into a high-concentration solution in which the impurities are concentrated. Locations of interest for osmotic power plants are river mouths, salt caverns or the like, since here high-concentration solutions and low-concentration solutions are available in large quantities. In this case, however, the process is highly dependent on the location, owing to the necessary boundary conditions.

There is, however, the possibility of combining the two sub-processes or directions, e.g., on the one hand the reverse osmosis and pressure retarded osmosis, on the other hand the electro dialysis and the reversed electro dialysis, or combinations of these sub-processes. A cycle is thus produced, and consequently a possibility for storing energy in a so-called osmotic storage. If, however, membrane processes, such as reverse osmosis or electro dialysis are used for separating or regenerating the working solution, only poor efficiencies can be achieved. This is due to limitations in the concentrating of the high-concentration solution, which may be caused by inorganic deposits, also referred to as scaling, or organic soilings, also referred to as fouling, and by a concentration polarization. This has the result that, overall, current-to-current efficiencies of only a maximum of 10% can be realized. This is unfavorable for the operation of an osmotic power plant.

If, however, thermal processes are used that include, for instance, vacuum distillation for the provision of high-concentration solutions, the aforementioned limitations are significantly less. However, owing to the high boiling point of water, and its high thermal capacity and high enthalpy of vaporization, the separation of a salt solution by the evaporation of water requires large amounts of energy. In the case of vacuum distillation or membrane distillation, however, it is possible to work with lower temperatures than in the case of conventional distillation. In particular, owing to the provision of the vacuum, waste heat sources can thus be used here at a comparatively low temperature level.

Thus, as in the case of thermal water treatment or drinking water treatment, this process also has the disadvantage that there are stringent requirements regarding the gas tightness of an installation in which the vacuum distillation is to take place. This results in comparatively high investment costs and maintenance costs. Moreover, there is a need for process steam, or a requirement for a large amount of electrical energy to maintain the vacuum. This, in turn, negatively affects the operating costs of the installation. It is therefore an object of the teachings herein to enable a method and an osmotic power plant, of the type stated at the outset, that has a particularly low resource requirement.

In the case of the method according to the invention for operating an osmotic power plant, a first solution, having a first concentration of at least one substance that can be dissolved in a solvent of the solution, and a second solution are provided. The second solution has a second, lesser concentration of the at least one substance. At least the first solution is provided by means of at least one thermal separating facility. In the at least one thermal separating facility, a starting solution that contains the at least one substance is introduced into an evaporator, through which there flows a gaseous medium. The at least one substance is discharged out of the evaporator by means of the gaseous medium. The at least one substance that is discharged in the gaseous medium is converted to a liquid phase in a condenser of the at least one thermal separating facility, in order to provide the first solution. In this case, used as the at least one substance in the starting solution is one that can more easily be converted to the gas phase than the solvent of the starting solution.

A thermal separating facility operated in such a manner is particularly well suited to the thermal separation of a mixture whose high-concentration and low-concentration solutions can be used for storing energy according to the principle of an osmotic storage. This is because, since the at least one substance has a higher vapor pressure and a lesser enthalpy of vaporization than the solvent, the at least one substance can be converted particularly easily to the gas phase in the thermal separating facility and can then be discharged, with the gaseous medium, out of the evaporator. Thus, at least one substance that is volatile, or that can be converted to a volatile form, is used in the starting solution, in that heat is supplied to the starting solution that contains the at least one substance.

Since the at least one substance is more easily converted to the gas phase than the solvent of the starting solution, the at least one substance can also be converted to a volatile form even at temperatures significantly below the boiling point of the solvent, and can therefore be discharged, with the gaseous medium, out of the evaporator.

Thus, the solvent is scarcely converted to the gas phase, or is converted only to a minor extent, but instead, the at least one substance dissolved in the solvent. The substance dissolved in the starting solution is thus converted to the gas phase in the evaporator, and is subsequently condensed back in the condenser.

Owing to the greater ease of conversion to the gas phase, or greater volatility, however, the at least one substance can be thermally separated particularly easily in the thermal separating facility. Consequently, such a starting solution is particularly practicable in the operation of the osmotic power plant. The method therefore has a particularly low resource requirement.

The second solution used in the osmotic power plant also need not contain the at least one substance at all. It is technically particularly simple and inexpensive if water is used as the solvent of the starting solution. Ammonium carbonate, in particular, can be used in this case as the at least one substance. This is because ammonium ions, carbonate ions, and other ionic, readily soluble compounds are then present in the water. At temperatures above 60° C., however, these ionic compounds decompose back into ammonia and carbon dioxide. Ammonia and carbon dioxide can be discharged particularly effectively, together with the gaseous medium, out of the evaporator. Moreover, upon lowering of the temperature in the condenser, ammonia and carbon dioxide can be converted back to a liquid phase, for instance in that ammonium ions and carbonate ions dissolve in the water that, together with the gaseous medium is discharged, as water vapor, out of the evaporator.

The system composed of ammonia and carbon dioxide therefore represents a material combination or substance combination that is particularly suitable for use in the method, in that ammonium carbonate is used as the at least one substance in the starting solution. Both the ammonia and the carbon dioxide can be discharged, together with the gaseous medium, out of the evaporator. However, the water is not separated into pure product water, on the one hand, and residual water have a higher ion content, on the other hand, by means of the thermal separating facility. Rather, the substance contained in the water, namely the ammonium carbonate, is separated from the solvent water in the thermal separating facility.

In addition or as an alternative to ammonium carbonate, however, it is also possible to use other substances that can be converted into volatile substances at particular temperatures that are lower than the evaporation temperature of the solvent. Possibilities in this case are substances or compounds that, depending on the boundary conditions, can be converted from a non-volatile into a readily volatile species. For examples, acids or bases may be used here, and weak organic or inorganic acids and/or bases. This is because the acids or bases are volatile in their non-charged, non-dissociated, form, but are non-volatile in their ionized form. In the case of an acid, for instance, the non-dissociated and non-hydrated form represents the highly volatile species. On the other hand, the dissociated, charged form, hydrated in the solvent water, represents the non-volatile species.

By conversion to the non-dissociated form, the acid or base can therefore be discharged, together with the gaseous medium, out of the evaporator and converted to the liquid phase upon subsequently being condensed. Also, such substances are easily and inexpensively available, and are practicable for use in operation of the separating facility with a low resource requirement. This applies to small-molecule acids such as acetic acid and/or formic acid. Additionally or alternatively, however, a polar organic compound that, although it does not dissociated in a solvent such as water, can nevertheless be effectively dissolved in the solvent, may be used as the at least one substance. This applies, for example, to alcohols and to short-chain alcohols such as methanol, ethanol, and the like. Such polar organic compounds can thus be thermally separated in the thermal separating facility, without conversion to a non-dissociated species, and subsequently converted back to the liquid phase in the condenser.

If the at least one acid or base is used as the at least one substance, the pH value in the at least one thermal separating facility may be set in such a manner that a greater proportion of the at least one acid or base is present in its non-dissociated form in the evaporator, at least in regions, than without the setting of the pH value. The pH value is the relevant boundary condition for the position of the balance between the volatile and the non-volatile form of the acid or base. The conversion of the acid to the non-dissociated form may be effected, for instance, by protonation of the dissociated form. The non-volatile form is thus provided by lowering of the pH value in the thermal separating facility.

Furthermore, deprotonation enables the acid to be converted back easily to the liquid phase. The setting of the pH value in the evaporator thus makes it possible to ensure a high yield as the acid or base is discharged, together with the gaseous medium, out of the evaporator. Analogously, if an acid is used, it can be ensured by deprotonation in the condenser that the acid can be converted to the liquid phase. Accordingly, a pH value that favors the dissociation of the acid or base can be set in the condenser.

The pH value at which the dissociated and the non-dissociated form of the acid or base are present in approximately equal concentrations is characterized by the pK_{S} value or pK_{B} value of the respective acid or base. With knowledge of the pK_{S} value or pK_{B} value of the respectively used acids or bases, the pH value to be set, respectively, in the evaporator and/or in the condenser can be determined. Thus, for example, the pH value in the evaporator may be set by addition of a further acid or base that has a greater acid strength or base strength than the at least one substance.

In some embodiments, in the condenser, the starting solution is used as a coolant for cooling the gaseous medium containing the at least one substance. The starting solution can then be preheated before being supplied to the evaporator. At the same time, the conversion of the at least one substance to the liquid phase in the condenser can be accomplished with a low resource requirement. Such a process control is instrumental in the low thermal energy requirement of the thermal separating facility.

In some embodiments, a temperature of the starting solution coming from the condenser is increased, and the starting solution having the increased temperature is trickled in a counterflow in relation to the gaseous medium in the evaporator. Increasing the temperature of the starting solution on the input side of the evaporator makes it possible to produce a controllable temperature gradient between the starting solution and the gaseous medium that is introduced into the evaporator. A useful temperature gradient can thus be realized in the evaporator. Furthermore, at a level in the evaporator, the temperature of the gaseous medium is always lower than that of the starting solution introduced into the evaporator at this level of the evaporator. A transfer of heat is effected from the falling starting solution to the rising gaseous medium. If a high temperature gradient is set, it is possible to achieve a transfer of the at least one substance into the gaseous medium in the case of trickling of the starting solution in an evaporator having a small surface area. The setting of a low temperature gradient results in a high efficiency in the operation of the thermal separating facility, but this requires a larger evaporator surface area.

In some embodiments, the solvent, after passing through the evaporator, is cooled to a temperature that is lower than the temperature of the gaseous medium that, coming from the condenser, is introduced into the evaporator, in the bottom region. Thus, as in the case of the evaporator, a useful temperature gradient can be realized in the condenser.

In some embodiments, the starting solution discharged out of the evaporator, depleted with respect to the at least one substance, is used to provide the second solution. A cycle can thus be realized, in which the separating of the first and the second solution occurs in the thermal separating facility, and energy is subsequently obtained in the osmotic power plant by means of these two solutions.

In some embodiments, the thermal separating facility can be operated in a batch process, e.g., in a discontinuous process. In this case, a certain quantity of the starting solution is first separated by means of the at least one thermal separating facility, and thus the first solution and the second solution are provided. Then, the energy that is contained in the first solution and in the second solution, and that can be recovered by mixing of the two solutions, can be used independently of the preparation of the two solutions.

In some embodiments, the at least one thermal separating facility is operated at a pressure that corresponds to a pressure in the environment of the at least one thermal separating facility. This makes the operation of the thermal separating facility a low resource requirement, since both the investment costs and the operating costs are significantly less than in the case of a thermal separating facility in which there is a vacuum relative to the pressure in the environment.

In some embodiments, at least the first solution is provided by means of at least two thermal separating facilities, wherein the solution originating from the condenser of a first separating facility, enriched with respect to the at least one substance, is supplied as a starting solution to the evaporator of a second separating facility. Such a series connection of thermal separating facilities makes it possible to achieve a strong concentration of the first solution.

In some embodiments, analogously, the solution that is depleted with respect to the at least one substance can be processed further in the second separating facility, in order to provide a second solution that is particularly reduced with respect to the at least one substance, or particularly highly depleted. The concentration difference between the first solution and the second solution can thus be exploited in the osmotic power plant.

In some embodiments, the first solution and the second solution are supplied to a facility in which energy is obtained by means of a reversed electro dialysis and/or by means of a pressure retarded osmosis. This is because the starting solution can thus be used particularly easily in a circuit, such that the method is a particularly low-loss method.

In some embodiments, a facility has a first inlet for a first solution of a first concentration of at least one substance that is soluble in a solvent of the first solution. The facility has a second inlet for a second solution that has a second, lesser concentration of the at least one substance. The first inlet is connected to a first reservoir for the first solution, and the second inlet is connected to a second reservoir for the second solution. At least the first reservoir is connected to at least one thermal separating facility. A starting solution, containing the at least one substance, and a gaseous medium are present in an evaporator of the at least one thermal separating facility. In this case, the at least one substance can be discharged out of the evaporator by means of the gaseous medium. The evaporator is connected to a condenser of the at least one thermal separating facility. The condenser is designed to convert the at least one substance, that is discharged in the gaseous medium, to a liquid phase. Used as the at least one substance in the starting solution is one that can more easily be converted to the gas phase than the solvent of the starting solution.

Such an osmotic power plant is of a particularly low resource requirement, since the at least one substance can be separated by means of the thermal separating facility with a low energy requirement, to provide the first solution.

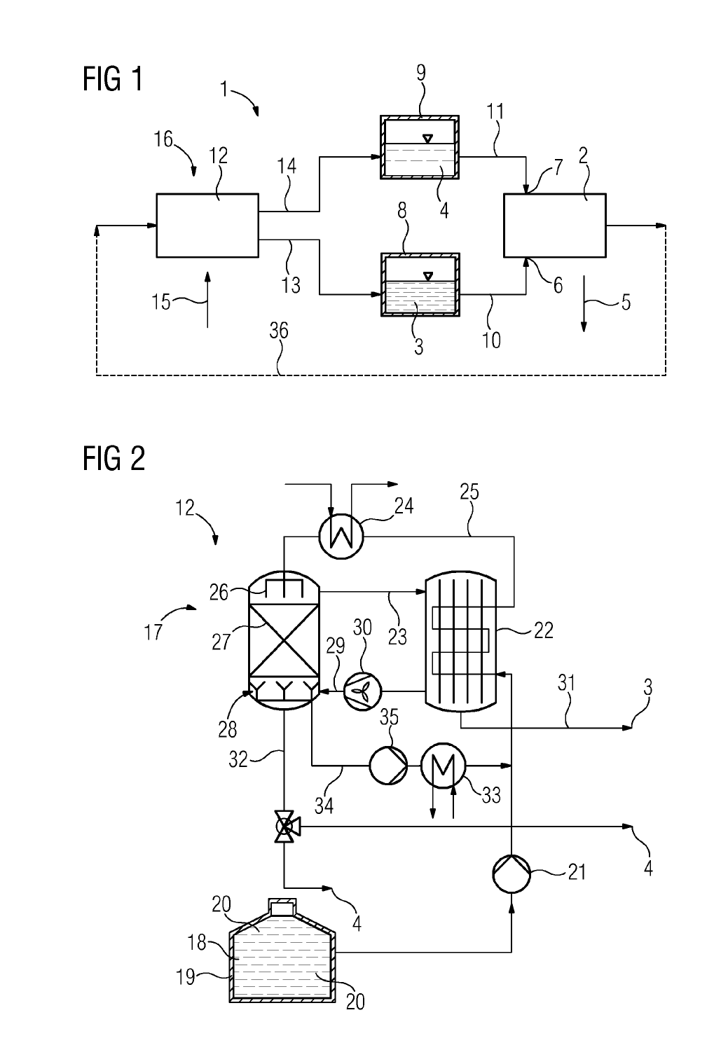

An osmotic power plant 1 shown in FIG. 1 comprises a facility 2 for producing energy. The facility 2 may operate according to the principle of reversed electro dialysis (RED), to provide a voltage by way of a charge separation. Additionally or alternatively the device 2 may produce energy by means of a process referred to as pressure retarded osmosis (PRO). In both cases, the driving force is a concentration difference between a first solution 3, in which a substance that is soluble in a solvent such as, for instance, water, is present in a high concentration, and a second solution 4, in which the at least one substance has a lesser concentration, or is even not present at all.

In some embodiments employing pressure retarded osmosis (PRO), the first solution 3 and the second solution 4 are separated in the facility 2 by means of a membrane that is permeable to the solvent. This has the effect that the solvent, for example, the water, flows out of the low-concentration solution 4 into the high-concentration solution 3. The water pressure that is produced in this case can then be used to provide electrical energy 5.

In the case of the reversed electro dialysis (RED), layers of membranes that are alternately permeable to anions and cations provide that a voltage forms across each membrane and thus, likewise, electrical energy 5 can be provided.

As shown in FIG. 1, the facility 2 has a first inlet 6 for the first solution 3, and a second inlet 7 for the second solution 4. The first solution 3 is stored in a first reservoir 8, and the second solution 4 in a second reservoir 9. The first reservoir 8 is connected to the first inlet 6 via a line 10, and the second reservoir 9 is connected to the second inlet 7 via a further line 11.

A thermal separating facility 12, which is illustrated in greater detail in FIG. 2, is used to provide the first solution 3 and the second solution 4. As represented in FIG. 1, the thermal separating facility 12 may be connected to the first reservoir 8 and the second reservoir 9 via respective lines 13, 14. In this case, the first solution 3 is introduced into the first reservoir 8 via the first line 13, and the second solution 4 is introduced into the second reservoir 9 via the second line 14.

As shown, the osmotic power plant 1 can be operated with a particularly low resource requirement, since the thermal separating facility 12 can be operated with a low electrical energy requirement 15, and a requirement by the thermal separating facility 12 for heat 16 or waste heat is also comparatively low. This is because the thermal separating facility 12 operates according to a principle in which a starting solution 18, which in the present case is provided in a schematically shown tank 19, is evaporated in an evaporator 17. The starting solution 18 in this case contains at least one substance 20 that is concentrated, by means of the thermal separating facility 12, in the first solution 3.

For this purpose, the starting solution 18 is first supplied to a condenser 22 by means of a pump 21. The starting solution 18 in this case is used in the condenser 22 as a coolant. The starting solution 18 in this case heats up. At the same time, the temperature of a medium such as, for example, air in the condenser 22, is reduced, which gaseous medium is supplied to the condenser 22 via a line 23. The line 23 may be connected in an upper region to the evaporator 17 into which the starting solution 18 is introduced, after the starting solution 18 has been heated in the condenser 22 and by means of a further heat exchanger 24.

The starting solution 18 preheated in the condenser 22 is thus heated further by means of the heat exchanger 24 by use of an external heat source, for instance a flow of a liquid or gaseous substance. A line 25, in which the starting solution 18 is carried from the condenser 22, via the heat exchanger 24, to the evaporator 17 leads to a water distributer 26 arranged in the evaporator 17. By means of the water distributor 26, structures 27 arranged in the evaporator 17, which may be embodied as lattices, are sprinkled with the heated starting solution 18.

The temperature of the downwardly flowing starting solution 18 drops in the top region of the evaporator 17, in which the water distributor 26 is located and in which the line 23 is connected to the evaporator 17, toward a bottom region 28 of the evaporator 17. Heat is drawn from the starting solution 18 by evaporation and heat transfer to the air. The air is introduced into the evaporator 17 via a line 29 connected to the evaporator 17 in the bottom region 28. This line 29 comprises a fan 30 connected on the inlet side to a bottom region of the condenser 22.

The temperature of the air flowing counter to the starting solution in the evaporator 17 therefore increases from the bottom region 287 of the evaporator 17 toward the top region of the evaporator 17. In stable operation with steady conditions, however, the temperature of the air always remains below the temperature of the starting solution 18 at a given level of the evaporator 17. A heat transfer is thereby effected, from the falling starting solution 18 to the rising air. As a result of the rising temperature, the air in the evaporator 17 can absorb increasingly more water vapor. The water in the starting solution 18 and the air thus form a counterflow heat exchanger in the evaporator 17.

In the embodiment shown, however, it is not only water vapor that is discharged out of the evaporator 17 with the air exiting the evaporator 17. Rather, the substance 20 is also discharged out of the evaporator 17 by means of the air or such a gaseous medium. This is because the substance 20 is such that it is volatile or can be converted to a volatile form that has a higher vapor pressure and a lesser evaporation enthalpy than water. In other words, the substance 20 is more easily converted to the gas phase than the water, which may serve as the solvent in the starting solution 18.

For example, ammonium carbonate may be used as the substance 20. Ammonium carbonate is readily soluble in water, but at temperatures above 60° C. decomposes back into ammonia and carbon dioxide. These gaseous components can be discharged out of the evaporator 17 with the air, and thus conveyed to the condenser 22. In the condenser 22, the substance 20 discharged with the air is then converted back to a liquid phase. This is because, in the condenser 22, the water vapor cools and water drops are formed, in which the ammonia and the carbon dioxide again dissolve. Thus, although in the evaporator 17 the solvent is also partly converted to the gas phase and discharged out of the evaporator, the substance 20, which is more easily converted to the gas phase than the solvent, in the form of water. The liquid phase in the form of the water with the substance 20 dissolved therein, but present in a higher concentration in comparison with the starting solution 18, can thus be discharged out of the condenser 22 via an outlet line 31. In this way, the first solution 3 can be provided by means of the thermal separating facility 12.

After passing through the evaporator 17, the starting solution 18, depleted with respect to the substance 20, is discharged via a line 32. The starting solution 18 may be cycled several times in order to achieve a high degree of separation. Heat recovery in this case is effected in the condenser 22. The starting solution 18 exiting the evaporator 17 via the line 32 and depleted with respect to the substance 20 is thus cooled, so that it can be supplied again, as a coolant, to the condenser 22.

The second solution 4, which is held in the second reservoir 9, may be provided, for example, in the form of the solution exiting the evaporator 17 and containing the substance 20 to a lesser extent. However, the solution may also be returned to the tank 19, and subsequently supplied again to the evaporator 17.

A plurality of the thermal separating facilities 12 illustrated on the basis of FIG. 2 may also be connected in series in the osmotic power plant 1, in order to achieve a greater concentration of the substance 20 in the first solution 3 and a corresponding depletion of the substance 20 in the second solution 4.

Other substances 20 that may be present in the starting solution 18 in addition or as an alternative to ammonium carbonate may comprise, for example, small weak organic and inorganic acids or bases. These substances 20 are volatile in their non-charged form, and non-volatile in their corresponding ionized form. In the case of small weak acids, the non-dissociated, and consequently non-hydrated, form represents the readily volatile species. Here, by setting of the pH value, it can be ensured that the volatile form is present. For example, it can be ensured, by addition of a stronger acid or base in the bottom region 28 of the evaporator 17, that the weak acid or base is present in its undissociated form.

Also possible as the at least one substance 20 are small polar organic compounds that also dissolve well in the solvent, e.g., water, without dissociating. For example, this applies to alcohols that, without conversion, separate thermally in the evaporator 17 from the starting solution 18 and can subsequently be condensed back in the condenser 22. Besides the ammonium carbonate, therefore, further substances classes, such as low-molecule acids, bases or alcohols, may be present in the starting solution 18.

To use the starting solution 18 for the purpose of providing the first solution 3, the starting solution 18 may be returned from the bottom region 28 of the evaporator 17, upstream from the condenser 22, in the thermal separating facility 12, via an optional line 34, in which, in particular, a pump 35 may be arranged. Thus, a recirculation of the starting solution 18 may be realized, in order to achieve a particularly extensive separation of the substance 20 from the starting solution 18.

Heat present in the starting solution 18, depleted with respect to the substance 20, may be removed in this case by means of a further heat exchanger 33, which is arranged in the line 34. The heat exchanger 33 serves to cool the depleted starting solution 18, such that it can be used as a coolant in the condenser 22. Furthermore, some of the heat that is supplied to the starting solution 18, by means of the heat exchanger 24, before it enters the evaporator 17 can thus be used for other processes.

After several cycles of the starting solution 18 through the evaporator 17, the concentration of the substance 20 in the tank 19 has been reduced to such an extent that the batch process can be ended. It is then also possible for only some of the solution, depleted with respect to the substance 20, to be drawn out of the tank 19 and, accordingly, for new starting solution 18 to be fed in. The process can thus be configured in a quasi-continuous manner.

In the osmotic power plant 1, the mixture obtained in the facility 2 by the balancing of the concentrations of the first solution 3 and of the second solution 4 can be used again as the starting solution 18, which is supplied in the osmotic power plant 1 to the thermal separating facility 12. The possibility of such a cycle is illustrated by an arrow 36 in FIG. 1.

The investment costs and the operating costs of the thermal separating facility 12 are particularly low. This is due to the fact that the thermal separating facility 12 is operated at ambient pressure. Moreover, the electrical energy requirement is low, as are also the other operating costs. The thermal separating facility 12 is also characterized by a particularly low maintenance requirement.

What is claimed is:

1. A method for operating an osmotic power plant having a first solution with a first concentration of a substance that can be dissolved in a solvent, and a second solution with a second, lesser concentration of the substance, and wherein the first solution is provided by a thermal separating facility, the method comprising:
supplying a starting solution containing the substance to the thermal separating facility;
evaporating the starting solution in an evaporator;
discharging the substance out of the evaporator with a gaseous medium flowing through the evaporator;
converting the discharged substance to a liquid phase in a condenser and thereby generating the first solution; and
wherein the substance is more easily converted to a gas phase than the solvent of the starting solution.

2. The method as claimed in claim 1, wherein the solvent comprises water, and
the substance comprises ammonium carbonate, an acid, a base, or at least one polar organic compound.

3. The method as claimed in claim 2, wherein the substance comprises an acid or a base; and
further comprising setting a pH value in the thermal separating facility so a greater proportion of the substance is present in its non-dissociated form in the evaporator than without the setting of the pH value.

4. The method as claimed in claim 3, wherein setting the pH value in the evaporator includes addition of a further acid or base that has a greater acid strength or base strength than the substance.

5. The method as claimed in claim 1, further comprising cooling the gaseous medium with the starting solution in the condenser.

6. The method as claimed in claim 5, further comprising increasing a temperature of the starting solution coming from the condenser; and
trickling the starting solution with increased temperature in a counterflow in relation to the gaseous medium in the evaporator.

7. The method as claimed in claim 1, further comprising:
cooling the solvent, after passing through the evaporator, to a temperature lower than a temperature of the gaseous medium coming from the condenser; and
introducing the cooled solvent into the evaporator in a bottom region.

8. The method as claimed in claim 1, further comprising using the starting solution discharged out of the evaporator, depleted with respect to the substance, to provide the second solution.

9. The method as claimed in claim 1, wherein the thermal separating facility operates at a pressure that corresponds to a pressure in the environment of the at least one thermal separating facility.

10. The method as claimed in claim 1, wherein the first solution is provided at least two thermal separating facilities;
wherein the solution originating from the condenser of a first separating facility, enriched with respect to the substance, is supplied as a starting solution to the evaporator of a second separating facility.

11. The method as claimed in claim 1, wherein the first solution and the second solution are supplied to a facility in which energy is obtained by means of a reversed electro dialysis or by means of a pressure retarded osmosis.

12. An osmotic power plant comprising:
a facility with a first inlet for a first solution having a first concentration of a substance soluble in a solvent; and
a second inlet for a second solution having a second, lesser concentration of the substance;
a first reservoir for the first solution connected to the first inlet; and
a second reservoir for the second solution connected to the second inlet;
wherein the first reservoir is connected to a thermal separating facility;
an evaporator with a starting solution containing the substance and a gaseous medium discharging the substance with the gaseous medium;
a condenser connected to the evaporator to convert the substance to a liquid phase; and
wherein the substance in the starting solution can more easily be converted to gas phase than the solvent of the starting solution.
